(19) United States
(12) Patent Application Publication
(10) Pub. No.: US 2017/0116117 A1
(43) Pub. Date: Apr. 27, 2017

(54) IDENTIFYING STORAGE DESCRIPTORS BASED ON A METRIC

(71) Applicant: SANDISK TECHNOLOGIES INC., PLANO, TX (US)

(72) Inventors: Amir Rozen, Rishon Lezion (IL); Shay Benisty, Beer Sheva (IL)

(21) Appl. No.: 14/922,678

(22) Filed: Oct. 26, 2015

(51) Int. Cl. G06F 12/06; G06F 12/02

(52) U.S. Cl. CPC G06F 12/0607; G06F 12/0246; G06F 2212/7201; G06F 2212/2022

(57) ABSTRACT

A data storage device includes a non-volatile memory device and a controller including a first memory. The first memory stores data indicating a metric. The controller is configured to receive data corresponding to a portion of a second memory of an access device. Multiple portions of the second memory are allocated for use by the controller, and the multiple portions are indicated by a plurality of descriptors that includes sizes of the multiple portions. The controller is also configured to determine a subset of the plurality of descriptors based on the metric and to determine a physical address corresponding to the portion of the second memory based on a descriptor of the subset of descriptors.

### FIELD OF THE DISCLOSURE

The present disclosure is generally related to data storage devices and more particularly to storage descriptors corresponding to portion(s) of memory.

### BACKGROUND

Storage devices enable users to store and retrieve data. For example, some storage devices include non-volatile memory to store data and a controller that coordinates access to the non-volatile memory and performs error detection/correction. According to some industrial standards/protocols, a host device may provide a read or write command to a data storage device. In non-volatile memory express (NVMe) systems, read or write commands may be associated with physical locations in a host memory at the host device. In some cases, the physical locations are indicated to the data storage device via scatter gather list(s) (SGL(s)).

A SGL may include multiple descriptors. One type of SGL descriptor, known as a data block descriptor, describes a host buffer. During a write operation, a controller of a storage device may retrieve data from host buffers described by the SGL and provide the data to the non-volatile memory for storage. During a read operation, the controller may send data read from the non-volatile memory for storage in the host buffers described by the SGL. Due to SGL size or other conditions, segments of a SGL (where each segment includes one or more descriptors) may be stored at a host device in non-contiguous fashion. To illustrate, each segment of the SGL (other than the last segment) may include pointer to a “next” segment, to enable the controller to retrieve and process each portion of the entire SGL.

When the data being transferred to the host buffers (e.g., during a read operation of the non-volatile memory) becomes available out-of-order, multiple descriptors of the SGL may be traversed, in order, to identify the appropriate host buffer for the data. For example, consider a SGL that describes X host buffers, such as host buffer 1, host buffer 2, . . . host buffer X. If data to be stored in the Nth host buffer (N<X) becomes available first, then descriptors 1, 2, . . . (N−1) would be traversed before reaching the Nth descriptor and determining the physical location (e.g., address) of the Nth host buffer at the host device. However, traversing large portions (or the entirety) of the SGL for out-of-order data operations may result in performance loss (e.g., reduced throughput) at the data storage device. In addition, including sufficient memory in the controller to store an entire pre-fetched SGL for traversal may increase cost, complexity, or both associated with the controller.

### BRIEF DESCRIPTION OF THE DRAWINGS

FIG. 1 is a diagram of a particular illustrative example of a system that includes a device, such as a data storage device, operable to identify storage descriptors based on a metric;

FIG. 2 is a ladder diagram of a particular illustrative example of operation at the system of FIG. 1;

FIG. 3 is a diagram that includes a particular illustrative example of a scatter gather list (SGL) of the system of FIG. 1;

FIG. 4 is a flowchart of a particular illustrative example of a method of operation at the system of FIG. 1; and

FIG. 5 is a flowchart of another particular illustrative example of a method of operation at the system of FIG. 1.

### DETAILED DESCRIPTION

The present disclosure describes systems and methods of using metrics to improve performance of out-of-order operations, such as when SGLs are used during read or write operations in accordance with NVMe. In accordance with the described techniques, a controller of a data storage device may collect, on-the-fly, statistical information about host buffers described by SGL descriptors. For example, the statistical information can include an average host buffer size and a size deviation. In other examples, more metrics, fewer metrics, and/or different metrics may be used. When data is available out-of-order, the controller may perform a non-linear search based on the metric(s) to identify the host buffer corresponding to the data. To illustrate, the controller may use the metric(s) to determine a subset (e.g., range) of SGL descriptors for the data, where one of the SGL descriptors in the subset corresponds to the host buffer for the data. By traversing through the SGL descriptors in the subset rather in the entire SGL to determine the physical memory location of the host buffer for the data, the controller may improve overall performance of the data storage device.

In some examples, the metrics are calculated and updated while fetching the SGL, before initiating data transfer with a non-volatile memory of the data storage device. Alternatively, the metrics can be updated in parallel with data transfer operations. For example, the metrics can be updated based on a later-fetched portion of the SGL while data transfer is performed based on an earlier-fetched portion of the SGL.

Particular aspects of the disclosure are described below with reference to the drawings. In the description, common or similar features or components may be designated by common reference numbers. As used herein, “exemplary” may indicate an example, an implementation, and/or an aspect, and should not be construed as indicating a preference or a preferred implementation.

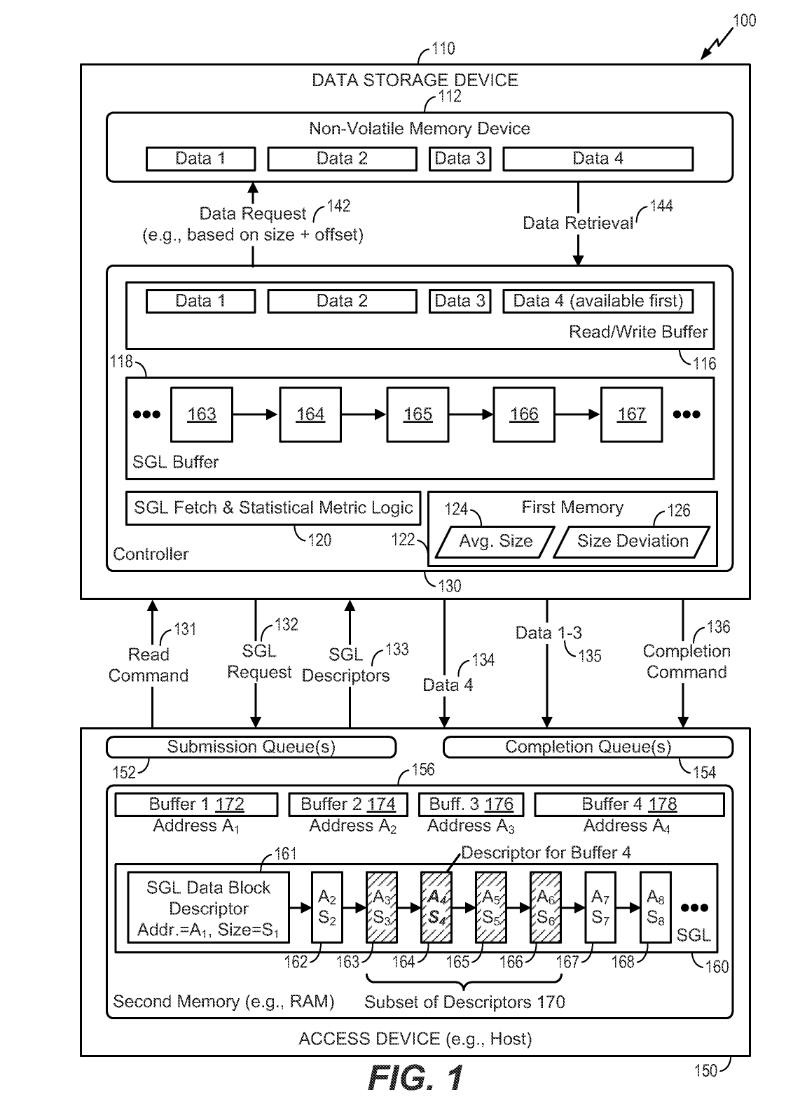

Referring to FIG. 1, a particular illustrative example of a system is depicted and generally designated 100. The system 100 includes a data storage device 110 and an access device 150 (e.g., a host device, a test device, a computing device, or a combination thereof). The data storage device 110 and the access device 150 may be operationally coupled via a connection, such as a peripheral component interconnect (PCI) bus compliant with a PCI Express (PCIe) specification. In some implementations, the data storage device 110 corresponds to or includes a solid state drive (SSD) data storage device that is configured to be embedded within the access device 150 or a removable flash memory data storage device that is configured to be removably coupled to the access device 150. In other implementations, the data storage device 110 corresponds to another device, such as an application-specific integrated circuit (ASIC) or a system-on-chip (SoC) device, as illustrative non-limiting examples. In some implementations, the system 100, the data storage device 110, one or more components of the data storage device 110, such as the memory device 112, or a combination thereof, may be integrated within a network-accessible data storage system. Examples of network-accessible data storage systems include an enterprise data system, a network-attached storage (NAS) system, or a cloud data storage system, as illustrative examples.

The data storage device 110 may include the memory device 112, such as a non-volatile memory device. The memory device 112 may include a flash memory (e.g., a NAND flash memory) or a resistive memory, such as a resistive random access memory (ReRAM), as illustrative examples. In some examples, the memory device 112 may have a three-dimensional (3D) memory configuration. As used herein, a 3D memory device may include multiple physical levels of storage elements (instead of having a single physical level of storage elements, as in a planar memory device). As an example, the memory device 112 may have a 3D vertical bit line (VBL) configuration. In a particular implementation, the memory device 112 is a non-volatile memory having a 3D memory array configuration that is monolithically formed in one or more physical levels of arrays of memory cells having an active area disposed above a silicon substrate. Alternatively, the memory device 112 may have another configuration, such as a two-dimensional (2D) memory configuration or a non-monolithic 3D memory configuration (e.g., a stacked die 3D memory configuration).

In some examples, the memory device 112 includes multiple memory dies. In such examples, when data is stored in the memory device 112, the data may be “striped” across one or more of the memory dies. Similarly, reading such data may include accessing one or more of the memory dies. In the illustrated example, the memory device 112 is illustrated as storing four distinct and differently-sized data items—Data 1, Data 2, Data 3, and Data 4, each of which may correspond to different files, parts of the same file, or other user data.

The data storage device 110 may include a controller 130 coupled to the memory device 112. In some implementations, the controller 130 corresponds to a semiconductor die (distinct from semiconductor die(s) of the memory device 112) that includes components of the controller 130. The controller 130 may include a read/write buffer 116, a scatter gather list (SGL) buffer 118, SGL fetch and statistical metric logic 120, a first memory 122 (e.g., random access memory (RAM)), or any combination thereof. The logic 120 may be implemented by software (e.g., instructions) executable by a processor (not shown) of the controller 130 to perform operations described herein. Alternatively, the logic 120 may include hardware (e.g., one or more circuits) configured to perform operations described herein. It should be noted that although the read/write buffer 116 and the SGL buffer 118 are shown as being part of the controller 130, in alternative embodiments one or both of the buffers 116, 118 may be external to the controller 130.

In an illustrative embodiment, the controller 130 may include additional components, such as an error correction coding (ECC) engine to detect and correct errors in data stored in the memory device 112. Examples of ECC schemes that may be used include, but are not limited to, Reed Solomon, Bose-Chaudhuri-Hocquenghem (BCH), low-density parity check (LDPC), and Turbo Code.

The access device 150 is configured to provide data to be stored at the memory device 112 (e.g., as part of a write command) and to request data to be read from the memory device 112 (e.g., as part of a read command) In an illustrative embodiment, the access device 150 may include a mobile telephone, a music player, a video player, a gaming console, an electronic book reader, a personal digital assistant (PDA), a computer (e.g., a laptop computer, a desktop computer, a tablet computer, etc.), another electronic device, or any combination thereof.

The access device 150 may include a processor (not shown) and memory accessible to the processor. For example, the memory of the access device 150 may include a second memory 156. At least a portion of the second memory 156 may be designated or allocated by the access device 150 for use by the controller 130 of the data storage device 110. For example, at least a portion of the second memory 156 may be allocated for use as host memory buffer(s) (HMB(s)). The second memory 156 may include volatile memory or non-volatile memory.

In an illustrative embodiment, the data storage device 110 and the access device 150 communicate via a non-volatile memory express (NVMe) interface. The access device 150 may include one or more submission queues 152 to store NVMe commands, such as read commands and write commands, that are to be performed by the data storage device 110. For example, a NVMe read command may indicate an amount of data to be read from the memory device 112 (which may be specified in numbers of logical blocks, bytes, etc., and may include “bit buckets” of data that are read from the memory device 112 but not transferred to the access device 150), a starting address (e.g., virtual address, physical address, logical block address, etc.) for the read operation, and a data pointer (DPTR) specifying where the read data is to be stored on the access device 150. Similarly, a NVMe write command may indicate an amount of data to be written, a destination address of the memory device 112 for the write operation, and a DPTR specifying a location on the access device 150 that the data is to be transferred from. When a SGL is used for a read command or a write command, the DPTR may enable the controller 130 to access at least an initial descriptor of a SGL. In one example, the DPTR may include the first segment or descriptor of the SGL. Alternatively, the DPTR may include a pointer to the first segment or descriptor of the SGL. In either case, and additional segments or descriptors of the SGL may be retrieved using a “next” pointer of the first segment or descriptor.

The access device 150 may also include one or more completion queues 154 into which the data storage device 110 may insert results of executing commands retrieved or received from the submission queue(s) 152. In an illustrative embodiment, the access device 150 includes a submission queue and a completion queue for each processor core in each processor of the access device 150. The access device 150 may also include additional submission queues and completion queues, such as for controller administration/management. In a particular embodiment, the data storage device 110 and the access device 150 use interrupt-driven communication. For example, to request that a read command 131 be executed, the access device 150 may insert the read command 131 into the submission queue(s) 152 and transmit a first interrupt to the data storage device 110. The controller 130 may respond to the first interrupt by retrieving the read command 131 from the submission queue(s) 152 and executing the read command 131. The data storage device 110 may store results (e.g., data, a completion code, an error code, etc.) of executing the read command 131 in the completion queue(s) 154 and may send a second interrupt to the access device 150 to indicate that execution of the read command 131 has been completed.

During operation, the access device 150 may allocate one or more portions of the second memory 156 for use by the controller 130. In the example of FIG. 1, four buffers 172, 174, 176, and 178 are allocated. A first buffer (Buffer 1) 172 has a first physical address A₁, a second buffer (Buffer 2) 174 has a second physical address A₂, a third buffer (Buffer 3) 176 has a third physical address A₃, and a fourth buffer (Buffer 4) 178 has a fourth physical address A₄ in the second memory 156. Moreover, as shown in FIG. 1, the buffers 172-178 may be allocated non-contiguously, may be separated by non-allocated portion(s) of the second memory 156, and/or may be differently sized.

The access device 150 may generate a SGL 160 to describe the allocated buffers, such as the allocated buffers 172-178. Generally, a SGL may be divided into segments, where each segment includes one or more descriptors. Examples of SGL descriptors may include data block descriptors, bit bucket descriptors, segment descriptors, and “last” segment descriptors. A SGL data block descriptor may include an address and a size, where the address specifies a starting physical memory address of a corresponding buffer and the size specifies the length (e.g., in bytes) of the buffer. To illustrate, in the example of FIG. 1, the SGL 160 includes descriptors 161-168. The first descriptor 161 is a data block descriptor for the first buffer 172 and indicates the address A₁ and a size S₁ of the first buffer. Similarly, data block descriptors 162, 163, and 164 indicate the addresses A₂, A₃, and A₄ and sizes S₂, S₃, and S₄ of the buffers 174, 176, and 178, respectively.

To request Data 1, Data 2, Data 3, and Data 4 be read from the memory device 112, the access device 150 may generate the read command 131. The controller 130 may receive the read command 131 and may send a SGL request 132 based on data (e.g., the DPTR) included in the read command 131. The controller 130 may receive SGL descriptors 133 in response to the SGL request 132. The SGL descriptors 133 may include one or more of the descriptors 161-168 of the SGL 160, or information determined therefrom. All or a subset of retrieved SGL descriptors 133 may be buffered in the SGL buffer 118, as shown.

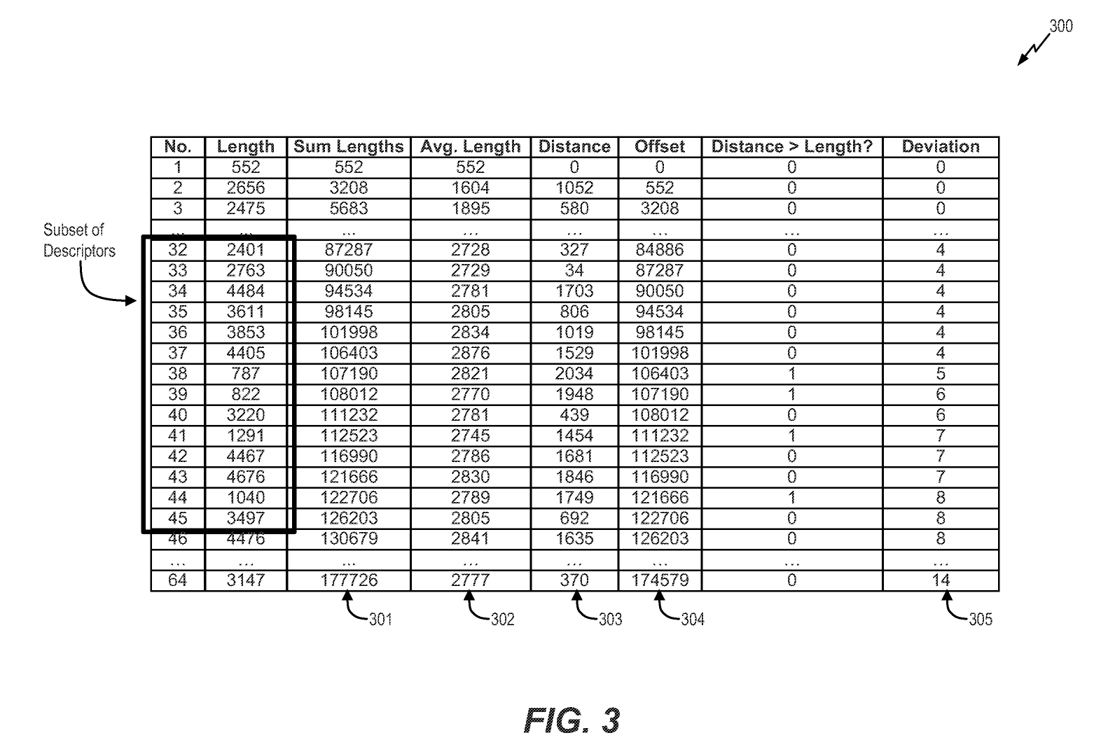

The logic 120 may determine metrics based on SGL descriptors received by the controller 130 and may store the metrics in the first memory 122. In the example of FIG. 1, the logic 120 determines an average size 124 and a size deviation 126 based on the SGL descriptors. The average size 124 may be an arithmetic mean of the sizes of the buffers specified by the data block descriptors of the SGL 160. The size deviation 126 may correspond to a deviation amongst the sizes of the buffers specified by the data block descriptors of the SGL 160. In an illustrative example, the logic 120 may update the average size 124 and the size deviation 126 each time a new data block descriptor of the SGL 160 is received. Calculating, updating, and using metrics is further described with reference to FIG. 3.

The controller 130 may also issue a data request 142 for Data 1, Data 2, Data 3, and Data 4 in response to the read command 131. In an illustrative example, the data request 142 is based on a size and an offset. In a particular aspect, the offset is measured from a “start” of the read command 131, such as a starting address specified by the read command 131. The data request 142 may be for particular memory sector addresses on particular memory dies or chips of the memory device 112. In a particular aspect, the memory device 112 includes read/write circuitry configured to sense bit values and store the bit values in latches, and the bit values may subsequently “toggled out” from the latches to the read/write buffer 116 of the controller 130 (illustrated in FIG. 1 as data retrieval 144). In some examples, the data may be read and/or arrive at the read/write buffer 116 out-of-order. For example, as shown in FIG. 1, even though Data 4 may sequentially follow Data 1-3 in the memory device 112 and/or in being specified by the read command 131 or SGL 160, Data 4 (which is to be transferred to the fourth buffer 178) may be available in the read/write buffer 116 before Data 1-3.

Because SGL descriptors can indicate host buffers that have variable size, to determine the address A₄ for the fourth buffer 178, current systems may traverse each descriptor of the SGL 160, starting from the initial descriptor 161, until the descriptor 164 for the fourth buffer 178 is found. In accordance with the described techniques, however, instead of traversing each and every descriptor of the SGL 160 until the descriptor for the fourth buffer 178 is found, the logic 120 may identify a subset 170 of descriptors based on the metrics stored at the first memory 122. In FIG. 1, the subset 170 includes the descriptors 163-167. An example of computations involved in identifying the subset 170 is described with reference to FIG. 3.

The logic 120 may perform an in-order traversal of the descriptors 163-167 in the subset 170 until the descriptor 164 corresponding to Data 4 is identified, and may then determine the physical address A4 of the fourth buffer 178 based on the descriptor 164. If descriptor(s) of the subset 170 are unavailable in the SGL buffer 118 (e.g., the SGL buffer 118 may too small to store the entire SGL 160), the controller 130 may retrieve the descriptor(s) from the access device 150 (e.g., via another SGL request 132). After the address A₄ is identified, the controller 130 may send Data 4 to the access device 150 for storage in the fourth buffer 178 based on the address A_{4,} as shown at 134. As additional data (e.g., Data 1-3) becomes available, the controller 130 may determine the physical addresses for the additional corresponding host buffers (e.g., the buffers 172-176) and may send the additional data to the access device 150, as shown at 135. In some examples, an ECC engine of the controller 130 corrects one or more bit error(s) in the data before the data is provided to the access device 150.

After all requested data is provided to the access device 150, the controller may issue a completion command 136 indicating that the read command 131 has been executed. Alternatively, if the read command 131 fails, the completion command 136 may indicate why the read command 131 failed (e.g., invalid memory address, invalid host buffer, etc.).

The system 100 of FIG. 1 thus illustrates on-the-fly determination and use of statistical metrics that may reduce the time taken to search a SGL for a descriptor corresponding to out-of-order data. For example, the logic 120 may use the average size 124 and the size deviation 126 to identify the subset 170 and may search the subset 170, rather than the entire SGL 160, to locate a specific host buffer (e.g., the fourth host buffer 178, in which Data 4 is to be transferred). When the subset 170 is traversed instead of the entire SGL, descriptors not included in the subset (e.g., the initial data block descriptor 161) may not be traversed. Use of statistical metrics may thus accelerate a host address search process in a pre-fetched SGL.

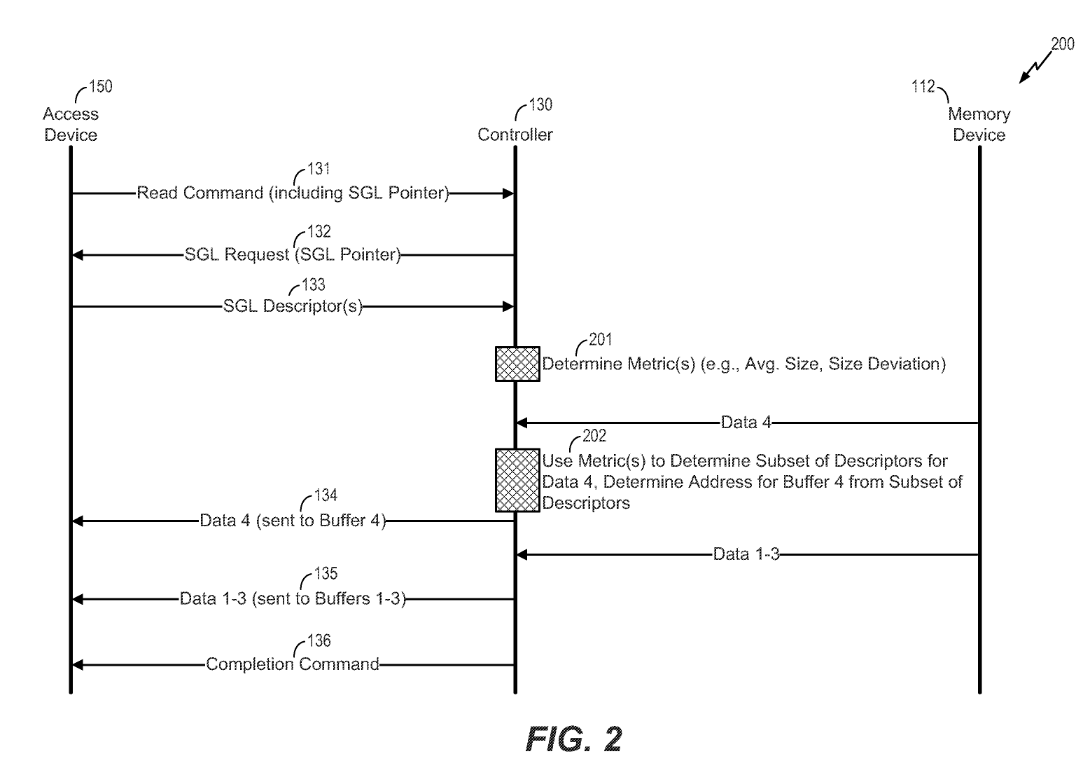

Referring to FIG. 2, a ladder diagram illustrating exemplary data transfer operations at the system 100 of FIG. 1 is shown and is generally designated 200. In particular, FIG. 2 illustrates data transfer between the access device 150, the controller 130, and the memory device 112 (e.g., a non-volatile memory).

The access device 150 may send the read command 131 to the controller 130, as shown. In a particular example, the read command 131 includes a SGL pointer. The controller 130 may send the SGL request 132 based on the SGL pointer and may receive the SGL descriptor(s) 133 in response to the SGL request 132. In a particular example, sending the SGL request 132 and receiving the SGL descriptor(s) 133 corresponds to a pre-fetch operation at the data storage device 110.

As the SGL descriptor(s) 133 are received, the controller 120 may determine statistical metrics, as shown at 201. For example, statistical metrics may include, but are not limited to, the average size 124 or the size deviation 126 described with reference to FIG. 1. Illustrative aspects of determining and using metrics are further descried with reference to FIG. 3.

As described with reference to FIG. 1, in some cases, the data requested by the read command 131 may arrive at the controller 130 out-of-order. For example, as shown in FIG. 2, Data 4 may arrive before Data 1-3. The controller 130 may use the statistical metric(s) to determine the subset 170 of descriptors for Data 4, and may determine the address A4 of the fourth buffer 178 based on a particular descriptor 164 of the subset 170, as shown at 202. The controller 130 may send Data 4 to the access device 150 (as shown at 134) before sending Data 1-3 to the access device 150 (as shown at 135). When the read command 131 is completed, or if an error occurs, the controller 130 may send the completion command 136 to the access device.

Referring to FIG. 3, an illustrative example of determining metrics based on a SGL is shown and is generally designated 300. For example, the SGL may correspond to the SGL 160 of FIG. 1 and one or more operations described with reference to FIG. 3 may be performed by the logic 120 of FIG. 1.

In the illustrated example, the SGL includes sixty-four data block descriptors. The first data block descriptor indicates that a first host buffer length has a length (i.e., size) of 552 bytes, the second data block descriptor indicates that a second host buffer has a length of 2656 bytes, etc. As data block descriptors are processed, a sum of buffer lengths 301, average buffer length 302, and distance from average buffer length 303 may be determined (e.g., by the logic 120 of FIG. 1). The average buffer length 302 may correspond to the average size 124 of FIG. 1. The logic 120 may also determine an offset 304 (e.g., in bytes) from a “start” of the command associated with the SGL. The logic 120 may further determine a deviation 305, which may correspond to the size deviation 126 of FIG. 1. In the example of FIG. 3, the deviation 305 is expressed as number of SGL descriptors. To illustrate, as shown in FIG. 3, the deviation 305 may be incremented each time a received SGL descriptor's length is exceeded by its distance from the “current” average buffer length 303.

The various statistical metrics illustrated in FIG. 3 may be used to determine a subset of descriptors for specific data that is available (e.g., out-of-order) for transfer to a host buffer. For example, assume that 1024 bytes read from non-volatile memory, such as the memory device 112 of FIG. 1, are available for transfer to an access device. An offset of those bytes from the start of the in-progress read command may be determined. For example, the offset may be 130000. The offset may be used to determine a subset of SGL descriptors based on the equation:

$$starting SGL descriptor = floor ( \frac{Offset}{average} - Deviation ) , \qquad Equation 1$$

where floor( ) is the rounding down function. In the described example, the average buffer length after all sixty-four data block descriptors have been encountered is 2777, and the deviation is 14. Thus, in the described example, the starting SGL descriptor of the subset is determined as:

$$starting SGL descriptor = floor ( \frac{150000}{2777} - 14 ) = 32$$

The subset of descriptors to be searched may thus start at SGL descriptor 32 and may include deviation=14 descriptors (i.e., the subset of descriptors may be from SGL descriptor 32 to SGL descriptor 45, as shown in FIG. 3). Given the offset of 130000, SGL descriptor 45 may be identified as the descriptor for the appropriate host buffer, and the 1024 bytes of data read from the non-volatile memory may be written to the host buffer starting from the address specified in SGL descriptor 45.

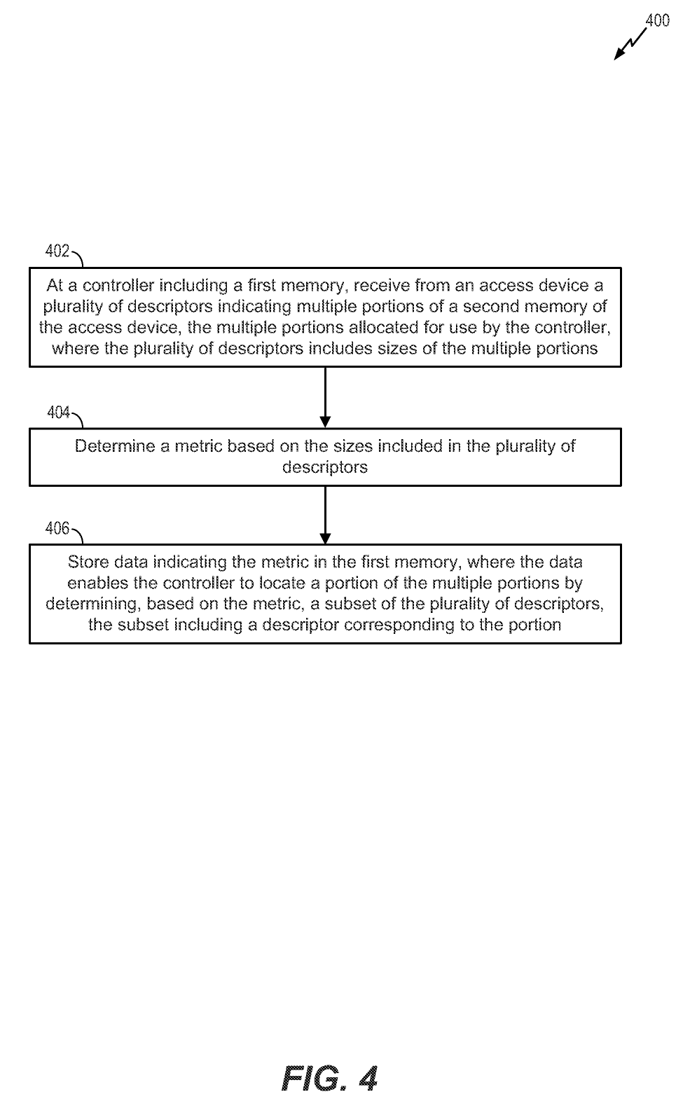

Referring to FIG. 4, an illustrative example of a method 400 of operation is shown. In a particular aspect, the method 400 may be performed at the system 100 of FIG. 1. The method 400 may include receiving, from an access device, a plurality of descriptors at a controller that includes a first memory, at 402. The plurality of descriptors may indicate multiple portions of a second memory of the access device, where the multiple portions are allocated for use by the controller and where the plurality of descriptors includes sizes of the multiple portions. For example, referring to FIG. 1, the controller 130 may include the first memory 122 and may receive the descriptors 161-168 of the SGL 160. Multiple portions of the second memory 156, such as the buffers 172-178, may be allocated for use by the controller 130.

The method 400 may also include determining a metric based on the sizes included in the plurality of descriptors, at 404. For example, referring to FIG. 1, the logic 120 may determine the average size 124 and the size deviation 126. In an illustrative aspect, the metric(s) may be determined as described with reference to FIG. 3.

The method 400 may further include storing data indicating the first metric in the first memory, at 406. The data may enable the controller to locate a portion of the multiple portions by determining, based on the metric, a subset of the plurality of descriptors, the subset including a descriptor corresponding to the portion. For example, referring to FIG. 1, the average size 124 and the size deviation 126 may be stored in the first memory 122 and may enable the logic 120 to determine the subset 170 and determine the address A4 of the fourth buffer 178 from the descriptor 164 of the subset 170.

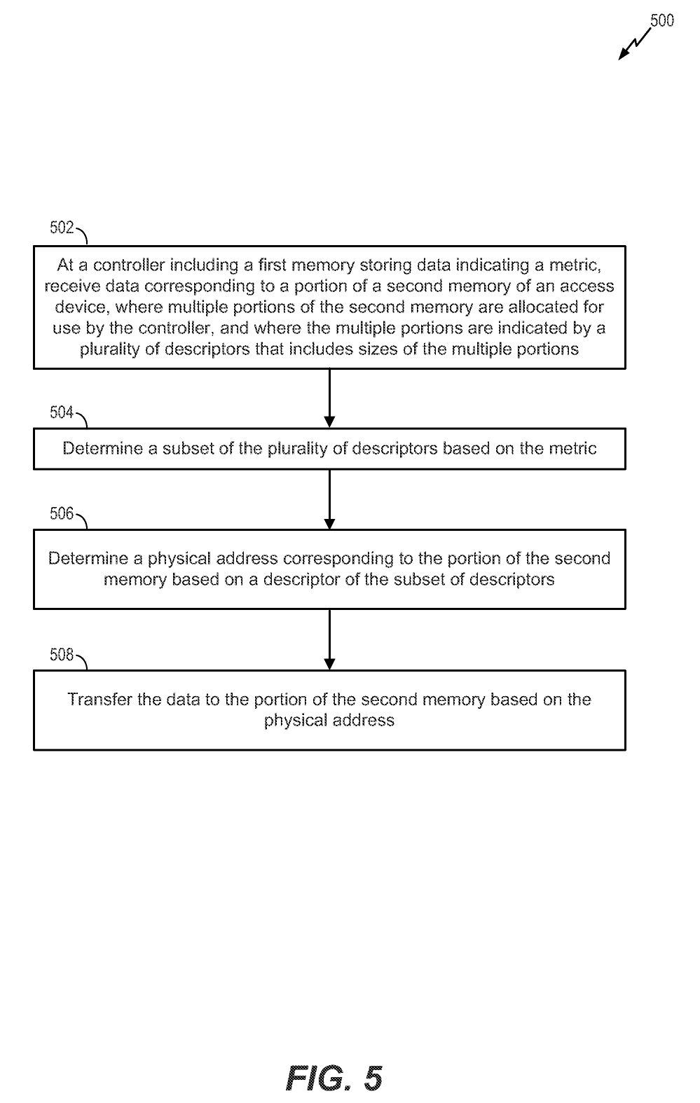

Referring to FIG. 5, another illustrative example of a method 500 of operation is shown. In a particular aspect, the method 500 may be performed at the system 100 of FIG. 1. The method 500 may include, at a controller including a first memory storing data indicating a metric, receiving data corresponding to a portion of a second memory of an access device, at 502. Multiple portions of the second memory may be allocated for use by the controller, where the multiple portions are indicated by a plurality of descriptors that includes sizes of the multiple portions. For example, referring to FIG. 1, the controller 130 may include the first memory 122 storing the average size 124 and size deviation 126, and the controller 130 may receive Data 4 in the read/write buffer 116. Multiple portions of the second memory 156, such as the buffers 172-178, may be allocated for use by the controller 130.

The method 500 may also include determining a subset of the plurality of descriptors based on the metric, at 504. For example, referring to FIG. 1, the logic 120 may determine the subset 170. In an illustrative aspect, the subset of descriptors may be determined as described with respect to FIG. 3 and Equation 1 above.

The method 500 may further include determining a physical address corresponding to the portion of the second memory based on a descriptor of the subset of descriptors, at 506. For example, referring to FIG. 1, the logic 120 may determine the address A₄ of the fourth buffer 178 based on the descriptor 164 in the subset 170. The method 500 may include transferring the data to the portion of the second memory based on the physical address, at 508. For example, referring to FIG. 1, the controller 130 may transfer Data 4 to the fourth buffer 178.

The methods 400, 500 of FIGS. 4-5 may thus reduce the time taken, and number of descriptors searched, to locate a specific buffer at an access device. Bus traffic between the data storage device and the access device may also be reduced, for example because fewer SGL descriptors may be transferred to the data storage device for searching. In a particular aspect, the described techniques may provide a linear relation between deviation (e.g., the size deviation 126 or the deviation 305) and transfer time for data. When the deviation is smaller, the search process and transfer to the host buffer may be faster.

In some implementations, a computer-readable medium stores instructions executable by a processing module to perform operations described herein. For example, the computer-readable medium, the processing module, or both may be included in the data storage device 110, the memory device 112, the controller 120, the first memory 122, the logic 120, the access device 150, the second memory 156, or any combination thereof

Although various components depicted herein are illustrated as block components and described in general terms, such components may include one or more microprocessors, state machines, or other circuits configured to enable such components to perform one or more operations described herein. For example, the logic 120 may represent physical components, such as hardware controllers, state machines, logic circuits, or other structures, to enable the controller 130 to perform operations described herein.

Alternatively or in addition, one or more components described herein may be implemented using a microprocessor or microcontroller programmed to perform operations, such as one or more operations of the methods 400, 500 of FIGS. 4-5. Instructions executed by the logic 120, the controller 130 and/or the data storage device 110 may be retrieved from a memory, such as a RAM or a read-only memory (ROM).

In some examples, the data storage device 110 may be coupled to, attached to, or embedded within one or more accessing devices, such as within a housing of the access device 150. For example, the data storage device 110 may be embedded within the access device 150 in accordance with a Joint Electron Devices Engineering Council (JEDEC) Solid State Technology Association Universal Flash Storage (UFS) configuration. To further illustrate, the data storage device 110 may be integrated within an electronic device, such as a mobile telephone, a computer (e.g., a laptop, a tablet, or a notebook computer), a music player, a video player, a gaming device or console, a component of a vehicle (e.g., a vehicle console), an electronic book reader, a personal digital assistant (PDA), a portable navigation device, or other device that uses internal non-volatile memory.

In one or more other implementations, the data storage device 110 may be implemented in a portable device configured to be selectively coupled to one or more external devices, such as a host device. For example, the data storage device 110 may be removable from the access device 150 (i.e., “removably” coupled to the device). As an example, the data storage device 110 may be removably coupled to the access device 150 in accordance with a removable universal serial bus (USB) configuration.

In some implementations, the system 100, the data storage device 110, or a component thereof may be integrated within a network-accessible data storage system, such as an enterprise data system, an NAS system, or a cloud data storage system, as illustrative examples. In some implementations, the data storage device 110 may include a solid state drive (SSD). The data storage device 110 may function as an embedded storage drive (e.g., an embedded SSD drive of a mobile device), an enterprise storage drive (ESD), a cloud storage device, a network-attached storage (NAS) device, or a client storage device, as illustrative, non-limiting examples. In some implementations, the data storage device 110 may be coupled to the access device 150 via a network. For example, the network may include a data center storage system network, an enterprise storage system network, a storage area network, a cloud storage network, a local area network (LAN), a wide area network (WAN), the Internet, and/or another network.

To further illustrate, the data storage device 110 may be configured to be coupled to the access device 150 as embedded memory, such as in connection with an embedded MultiMedia Card (eMMC®) (trademark of JEDEC Solid State Technology Association, Arlington, Va.) configuration, as an illustrative example. The data storage device 110 may correspond to an eMMC device. As another example, the data storage device 110 may correspond to a memory card, such as a Secure Digital (SD®) card, a microSD® card, a miniSD™ card (trademarks of SD-3C LLC, Wilmington, Del.), a MultiMediaCard™ (MMC™) card (trademark of JEDEC Solid State Technology Association, Arlington, Va.), or a CompactFlash® (CF) card (trademark of SanDisk Corporation, Milpitas, Calif.). The data storage device 110 may operate in compliance with a JEDEC industry specification. For example, the data storage device 110 may operate in compliance with a JEDEC eMMC specification, a JEDEC Universal Flash Storage (UFS) specification, one or more other specifications, or a combination thereof.

The first memory 122 and/or the memory device 112 may include a resistive random access memory (ReRAM), a flash memory (e.g., a NAND memory, a NOR memory, a single-level cell (SLC) flash memory, a multi-level cell (MLC) flash memory, a divided bit-line NOR (DINOR) memory, an AND memory, a high capacitive coupling ratio (HiCR) device, an asymmetrical contactless transistor (ACT) device, or another flash memory), an erasable programmable read-only memory (EPROM), an electrically-erasable programmable read-only memory (EEPROM), a read-only memory (ROM), a one-time programmable memory (OTP), another type of memory, or a combination thereof In a particular embodiment, the data storage device 110 is indirectly coupled to the access device 150 via a network. For example, the data storage device 110 may be a network-attached storage (NAS) device or a component (e.g., a solid-state drive (SSD) component) of a data center storage system, an enterprise storage system, or a storage area network. The first memory 122 and/or the memory device 112 may include a semiconductor memory device.

Semiconductor memory devices include volatile memory devices, such as dynamic random access memory (“DRAM”) or static random access memory (“SRAM”) devices, non-volatile memory devices, such as resistive random access memory (“ReRAM”), magnetoresistive random access memory (“MRAM”), electrically erasable programmable read only memory (“EEPROM”), flash memory (which can also be considered a subset of EEPROM), ferroelectric random access memory (“FRAM”), and other semiconductor elements capable of storing information. Each type of memory device may have different configurations. For example, flash memory devices may be configured in a NAND or a NOR configuration.

The memory devices can be formed from passive and/or active elements, in any combinations. By way of non-limiting example, passive semiconductor memory elements include ReRAM device elements, which in some embodiments include a resistivity switching storage element, such as an anti-fuse, phase change material, etc., and optionally a steering element, such as a diode, etc. Further by way of non-limiting example, active semiconductor memory elements include EEPROM and flash memory device elements, which in some embodiments include elements containing a charge region, such as a floating gate, conductive nanoparticles, or a charge storage dielectric material.

Multiple memory elements may be configured so that they are connected in series or so that each element is individually accessible. By way of non-limiting example, flash memory devices in a NAND configuration (NAND memory) typically contain memory elements connected in series. A NAND memory array may be configured so that the array is composed of multiple strings of memory in which a string is composed of multiple memory elements sharing a single bit line and accessed as a group. Alternatively, memory elements may be configured so that each element is individually accessible, e.g., a NOR memory array. NAND and NOR memory configurations are exemplary, and memory elements may be otherwise configured.

The semiconductor memory elements located within and/or over a substrate may be arranged in two or three dimensions, such as a two dimensional memory structure or a three dimensional memory structure. In a two dimensional memory structure, the semiconductor memory elements are arranged in a single plane or a single memory device level. Typically, in a two dimensional memory structure, memory elements are arranged in a plane (e.g., in an x-z direction plane) which extends substantially parallel to a major surface of a substrate that supports the memory elements. The substrate may be a wafer over or in which the layer of the memory elements are formed or it may be a carrier substrate which is attached to the memory elements after they are formed. As a non-limiting example, the substrate may include a semiconductor such as silicon.

The memory elements may be arranged in the single memory device level in an ordered array, such as in a plurality of rows and/or columns. However, the memory elements may be arrayed in non-regular or non-orthogonal configurations. The memory elements may each have two or more electrodes or contact lines, such as bit lines and word lines.

A three dimensional memory array is arranged so that memory elements occupy multiple planes or multiple memory device levels, thereby forming a structure in three dimensions (i.e., in the x, y and z directions, where the y direction is substantially perpendicular and the x and z directions are substantially parallel to the major surface of the substrate). As a non-limiting example, a three dimensional memory structure may be vertically arranged as a stack of multiple two dimensional memory device levels. As another non-limiting example, a three dimensional memory array may be arranged as multiple vertical columns (e.g., columns extending substantially perpendicular to the major surface of the substrate, i.e., in the y direction) with each column having multiple memory elements in each column. The columns may be arranged in a two dimensional configuration, e.g., in an x-z plane, resulting in a three dimensional arrangement of memory elements with elements on multiple vertically stacked memory planes. Other configurations of memory elements in three dimensions can also constitute a three dimensional memory array.

By way of non-limiting example, in a three dimensional NAND memory array, the memory elements may be coupled together to form a NAND string within a single horizontal (e.g., x-z) memory device levels. Alternatively, the memory elements may be coupled together to form a vertical NAND string that traverses across multiple horizontal memory device levels. Other three dimensional configurations can be envisioned wherein some NAND strings contain memory elements in a single memory level while other strings contain memory elements which span through multiple memory levels. Three dimensional memory arrays may also be designed in a NOR configuration and in a ReRAM configuration.

Typically, in a monolithic three dimensional memory array, one or more memory device levels are formed above a single substrate. Optionally, the monolithic three dimensional memory array may also have one or more memory layers at least partially within the single substrate. As a non-limiting example, the substrate may include a semiconductor such as silicon. In a monolithic three dimensional array, the layers constituting each memory device level of the array are typically formed on the layers of the underlying memory device levels of the array. However, layers of adjacent memory device levels of a monolithic three dimensional memory array may be shared or have intervening layers between memory device levels.

Alternatively, two dimensional arrays may be formed separately and then packaged together to form a non-monolithic memory device having multiple layers of memory. For example, non-monolithic stacked memories can be constructed by forming memory levels on separate substrates and then stacking the memory levels atop each other. The substrates may be thinned or removed from the memory device levels before stacking, but as the memory device levels are initially formed over separate substrates, the resulting memory arrays are not monolithic three dimensional memory arrays. Further, multiple two dimensional memory arrays or three dimensional memory arrays (monolithic or non-monolithic) may be formed on separate chips and then packaged together to form a stacked-chip memory device.

Associated circuitry is typically used for operation of the memory elements and for communication with the memory elements. As non-limiting examples, memory devices may have circuitry used for controlling and driving memory elements to accomplish functions such as programming and reading. This associated circuitry may be on the same substrate as the memory elements and/or on a separate substrate. For example, a controller for memory read-write operations may be located on a separate controller chip and/or on the same substrate as the memory elements.

One of skill in the art will recognize that this disclosure is not limited to the two dimensional and three dimensional exemplary structures described but cover all relevant memory structures within the spirit and scope of the disclosure as described herein and as understood by one of skill in the art. The illustrations of the embodiments described herein are intended to provide a general understanding of the various embodiments. Other embodiments may be utilized and derived from the disclosure, such that structural and logical substitutions and changes may be made without departing from the scope of the disclosure. This disclosure is intended to cover any and all subsequent adaptations or variations of various embodiments. Those of skill in the art will recognize that such modifications are within the scope of the present disclosure.

The above-disclosed subject matter is to be considered illustrative, and not restrictive, and the appended claims are intended to cover all such modifications, enhancements, and other embodiments, that fall within the scope of the present disclosure. Thus, to the maximum extent allowed by law, the scope of the present disclosure is to be determined by the broadest permissible interpretation of the following claims and their equivalents, and shall not be restricted or limited by the foregoing detailed description.

1. A data storage device comprising:
a non-volatile memory device; and
a controller including a first memory, wherein the first memory stores data indicating a metric, wherein the controller is configured, during a read or write operation associated with a list of data items, to:
receive a second data item of the list prior to receiving a first data item that precedes the second data item in the list, the second data item corresponding to a portion of a second memory of an access device, wherein multiple portions of the second memory are allocated for use by the controller, and wherein each portion of the multiple portions is indicated by a corresponding descriptor of a plurality of descriptors, the corresponding descriptor including a size of the portion;
determine a subset of the plurality of descriptors based on the metric; and
determine a physical address corresponding to the portion of the second memory based on a descriptor of the subset of descriptors.

2. The data storage device of claim 1, wherein the controller is configured to communicate with the access device via a non-volatile memory express (NVMe) interface.

3. The data storage device of claim 1, wherein the plurality of descriptors are part of a scatter gather list (SGL) that specifies addresses and sizes of the multiple portions.

4. The data storage device of claim 1, wherein the multiple portions are non-contiguous.

5. The data storage device of claim 1, wherein the metric corresponds to an average size of the multiple portions.

6. The data storage device of claim 1, wherein the metric corresponds to a size deviation amongst the multiple portions.

7. The data storage device of claim 1, wherein the controller is further configured to determine the metric based on the plurality of descriptors.

8. The data storage device of claim 1, wherein the controller is further configured to transfer the data indicating the metric to the portion of the second memory based on the physical address.

9. The data storage device of claim 1, wherein the controller is further configured to receive a command from the access device, wherein the command causes the controller to access at least an initial descriptor of the plurality of descriptors.

10. The data storage device of claim 1, wherein the access device includes a host device and wherein each of the multiple portions corresponds to a host buffer allocated in the second memory.

11. The data storage device of claim 1, wherein a size of a first portion of the multiple portions is different from a size of a second portion of the multiple portions.

12. The data storage device of claim 1, wherein the non-volatile memory device comprises a NAND flash memory.

13. A device comprising:
first means for storing data;
means for storing a metric;
means for receiving, during a read or write operation associated with a list of data items, a second data item of the list prior to receiving a first data item that precedes the second data item in the list, the second data item corresponding to a portion of second means for storing data, wherein multiple portions of the second means for storing data are allocated for use during the read or write operation, and wherein each portion of the multiple portions is indicated by a corresponding descriptor of a plurality of descriptors, the corresponding descriptor including a size of the portion; and
means for determining a subset of the plurality of descriptors based on the metric and for determining a physical address corresponding to the portion of the second means for storing data based on a descriptor of the subset of descriptors.

14. The device of claim 13, wherein the metric corresponds to an average size of the multiple portions.

15. The device of claim 13, wherein the metric corresponds to a size deviation amongst the multiple portions.

16. (canceled)

17. The device of claim 13, wherein the plurality of descriptors corresponds to a scatter gather list (SGL) and wherein the subset of descriptors does not include an initial SGL data block descriptor of the SGL.

18. A method comprising:
at a data storage device that includes a controller coupled to a non-volatile memory device, the controller including a first memory and the data storage device coupled to an access device that includes a second memory, performing:
receiving, from the access device, a plurality of descriptors indicating multiple portions of the second memory, the multiple portions allocated for use by the controller, wherein each portion of the multiple portions is indicated by a corresponding descriptor of the plurality of descriptors, the corresponding descriptor including a size of the portion;
determining a metric based on he sizes included in the plurality of descriptors; and
storing data indicating the metric in the first memory,
wherein the data enables the controller to locate, during a read or write operation associated with a list of data items, a portion of the multiple portions by determining, based on the metric, a subset of the plurality of descriptors, the subset including a descriptor corresponding to the portion, wherein the portion corresponds to a second data item of the list that is received at the controller prior to receiving a first data item that precedes the second data item in the list.

19. The method of claim 18, further comprising determining, based on the descriptor, a physical address corresponding to the portion.

20. The method of claim 19, further comprising transferring data to the portion of the second memory based on the physical address.

21. The data storage device of claim 1, wherein the controller is configured to perform in-order traversal of at least one descriptor of the subset.
